(19) United States
(12) Patent Application Publication
(10) Pub. No.: US 2025/0260130 A1
(43) Pub. Date: Aug. 14, 2025

(54) ELECTROCHEMICAL CELL WITH ANODE FRAME CONFINEMENT

(71) Applicant: Zeta Energy Corporation, Houston, TX (US)

(72) Inventors: Abdul-Rahman Olabode Raji, Houston, TX (US); Yavuz Savsatli, Houston, TX (US); Mohammadjavad Mohebinia, Houston, TX (US); Tuo Wang, Houston, TX (US)

(21) Appl. No.: 19/035,010

(22) Filed: Jan. 23, 2025

Related U.S. Application Data
(60) Provisional application No. 63/553,052, filed on Feb. 13, 2024.

(51) Int. Cl. H01M 50/477; H01M 4/36; H01M 4/38; H01M 4/587; H01M 50/105; H01M 50/109; H01M 50/486

(52) U.S. Cl. CPC H01M 50/477; H01M 4/366; H01M 4/382; H01M 4/587; H01M 50/105; H01M 50/109; H01M 50/486

(57) ABSTRACT

An electrochemical cell has an anode of an active anode material disposed opposite a cathode of an active cathode material. The anode active material is confined laterally by an impermeable anode frame to prevent the anode active material from expanding the area of the anode as the cell is charged and discharged.

### CROSS REFERENCE TO RELATED APPLICATION

This application claims priority to U.S. Provisional Patent Application 63/553,052 entitled “Electrochemical Cell with Anode Frame Confinement” filed 13 Feb. 2024 and incorporated herein by reference.

### BACKGROUND

An electric battery includes one or more electric cells. Each cell includes a positive electrode (cathode) and a negative electrode (anode) physically separated by an ion conductor (electrolyte). When a cell is discharged to power an external circuit, the anode supplies negative charge carriers (electrons) to the cathode via the external circuit and positive charge carriers (cations) to the cathode via the internal electrolyte. During charging, an external power source drives electrons from the cathode to the anode and the resultant charge imbalance pulls cations from the cathode to the anode via the electrolyte.

Lithium-ion (Li-ion) batteries store charge in the anode as Li cations (aka Li ions). Li-ion cells are rechargeable and ubiquitous in mobile communications devices and electric vehicles due to their high energy density, a lack of memory effect, and low self-discharge rate. Lithium-metal cells store charge in the anode as lithium metal, which is superior to Li ions due to a higher theoretical specific capacity, lower electrochemical potential, and lower density. Unfortunately, rechargeable lithium-metal cells have yet to be commercialized at scale.

### BRIEF DESCRIPTION OF THE DRAWINGS

The detailed description is illustrated by way of example, and not by way of limitation, in the figures of the accompanying drawings and in which like reference numerals refer to similar elements and in which:

FIG. 1A depicts a partial cell 100 in accordance with an embodiment in which a frame 105 is used in an electrochemical cell;

FIG. 1B depicts an expanded view of a full cell 150 with components from partial cell 100 of FIG. 1A; and

FIG. 2 is an expanded view of an electrochemical cell 200, a coin cell, with a metal anode 205 opposite the active surface of a cathode 210 and separated therefrom via a separator 215.

### DETAILED DESCRIPTION

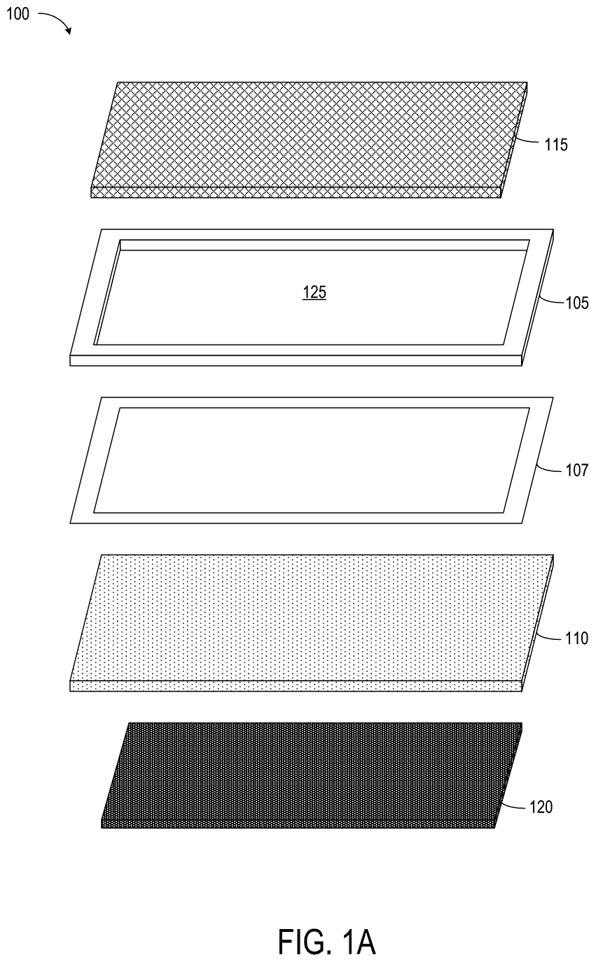

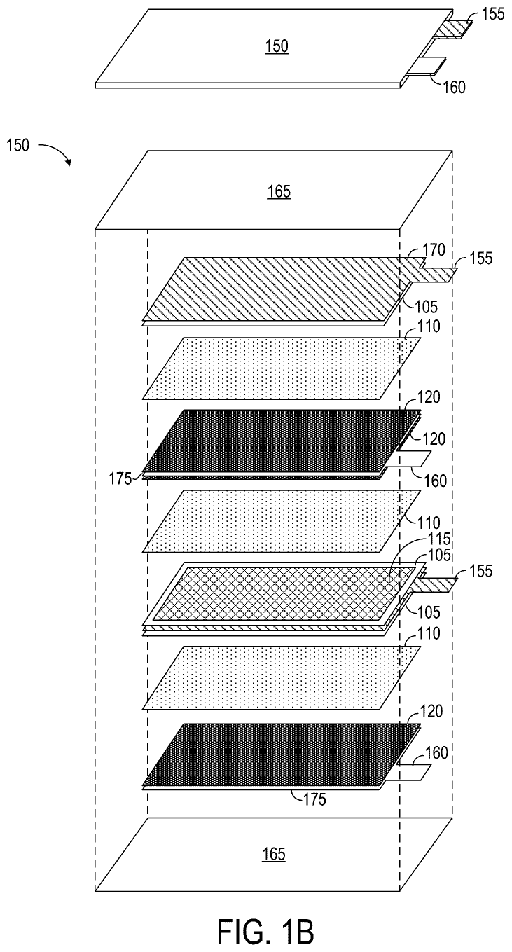

FIG. 1 depicts a partial cell 100 in accordance with an embodiment in which a frame 105 is used in an electrochemical cell (e.g., a pouch, prismatic, or cylindrical cell). An adhesive 107, e.g. polyvinylidene fluoride, bonds frame 105 to a separator 110. When partial cell 100 is assembled into a complete cell, frame 105 frames an anode 115 of e.g. lithium metal on a side of separator 110 opposite a cathode electrode 120. Frame 105 defines an opening 125 in a plane parallel to the active surface of cathode 120. After assembly, anode 115 is confined laterally within opening 125 to prevent the anode active material, e.g. lithium metal, from expanding the area of the active surface of anode 115 as the assembled cell is charged and discharged.

Adhesive 107 can be on either or both sides of frame 105, and each instance can include an aperture like opening 125 more or less matching that of frame 105. Adhesive 107 is shown separately for ease of illustration but may be a coating or layer on a surface to be bonded in assembly. Anode 115 can overlap or be confined within frame 105 after cell 100 is assembled. Separator 110 extends over an area that entirely overlaps and extends beyond the periphery of opening 125. Separator 110 is wetted with an electrolyte (not shown) that contains a dissolved salt of a metal, the ionic form of which is used to conduct charge. The area of separator 110 exceeds the area of anode 115, fully covering opening 125. In other embodiments, separator 110 is or includes a solid electrolyte to facilitate the movement of ions (e.g. of Li). The area of cathode 120 is coextensive with opening 125 in this example. In other embodiments the cathode area less than that of opening 125.

Frame 105 addresses peripheral accumulation by confining the anode active material within opening 125. Frame 105 is a barrier to ionic conduction, mass transport, and anode material migration, especially metallic lithium, to or beyond the periphery of the anode. Frame 105 can be of a compressible, non-conductive polymer that is impermeable to the electrolyte, thus forming a seal effective against creep migration of the active anode material. In another embodiment, frame 105 may be formed as part of an anode structure and disposed at the periphery of anode 115.

In some embodiments, anode 115 is coated or laminated with frame 105 at the periphery. Non-porous frame 105 and porous separator 110 can be formed together of the same or different materials. Frame 105 can distribute local electric fields more uniformly to reduce peripheral metal accumulation. During assembly, frame 105 ensures precise fit and alignment of battery components, and the resultant anode confinement enhances safety, reliability, and cell life.

Anode 115 is a lithium foil in this example but can be elsewise in other embodiments. Anode 115 can include an active layer in which a carpet of carbon nanotubes is alternatively coated with and depleted of metal when charged and discharged. For a suitable anode, see U.S. Patent Publication 2022/0209216 to Salvaterra et al., which is incorporated herein by reference. Cathode 120 can be of any number of available cathode active materials, including a sulfurized-carbon material detailed in the above-referenced document.

FIG. 1B includes assembled and expanded views of a pouch cell 150 that includes components of the type described above in connection with FIG. 1A. Assembled pouch cell 150, at the top of the page, includes a sealed, flexible foil pouch that contains electrode and electrolyte materials. Stacks of negative and positive tabs 155 and 160 extend from the foil pouch. Tabs are typically bonded using ultrasonic or laser welding.

In the expanded view, cell 150 is a sandwich structure with alternating anode and cathode elements between pouch halves 165. Pouch halves 165 need not be separate sheets but are shown so for ease of illustration. The pouch is typically a laminated film composed of aluminum and polymer layers that, when encompassing the electrically active materials, provides a barrier against environmental factors like moisture and oxygen and keeps the internal components from contacting other conductive materials that could lead to shorts.

The uppermost electrode is a copper film 170 with one of negative tabs 155 and anode material (not shown) bounded by a frame 105 on the underside. A separator 110 and electrolyte (not shown) separates this uppermost electrode from a two-sided cathode electrode in which an aluminum film 175 has a tab 160 and is coated on both sides with layers of cathode material 120. Another separator 110 and the electrolyte separates this cathode electrode from a two-sided anode electrode like the uppermost electrode but with anode material 115 and a frame 105 on both sides. Third and final separator 110 and the electrolyte separates this anode electrode from a one-sided cathode electrode. The number of electrode layers can be more or fewer, and the assembly can be wound or stacked.

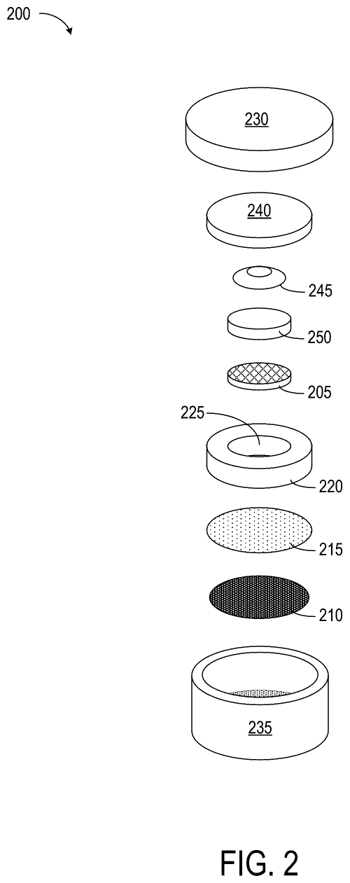

FIG. 2 is an expanded view of an electrochemical cell 200, a coin cell, with a metal anode 205 opposite the active surface of a cathode 210 and separated therefrom via a separator 215. A frame 220 defines an opening 225 in a plane parallel to the active surface of cathode 210. When cell 200 is assembled anode 205 is confined laterally within opening 225 to prevent the anode active material, e.g. lithium metal, from expanding the area of anode 205 as cell 200 is charged and discharged.

Negative and positive terminals 230 and 235 are brought together in assembly to form a case. Though not shown, a sealing ring electrically isolates terminals 230 and 235 and seals the cell contents. When assembled, a spacer 240 of stainless-steel compresses frame 220, a polymer in this embodiment, to secure separator 215 and cathode 210 to positive terminal 235. Assembly also compresses a Belleville spring 245 that urges a second spacer 250 of e.g. stainless steel to press anode 205 against separator 215.

In conventional cells, repeated charge and discharge cycles can cause metal to accumulate around the perimeter of the anode. The accumulated metal can extend to the case and thus short the cell. Peripheral metal accumulation, and thus cell performance, can vary considerably between cells. This lack of consistency can introduce severe quality issues into cell performance and pose severe safety hazards via short circuits.

The foregoing discussion focuses on electrochemical cells that employ lithium ions as charge carriers but other charge carriers can be used. Moreover, anode frames can be adapted for cathodes, and for use in cells of other shapes and sizes. Other variations will be obvious to those of ordinary skill in the art. Therefore, the spirit and scope of the appended claims should not be limited to the foregoing description. Only those claims specifically reciting “means for” or “step for” should be construed in the manner required under the sixth paragraph of 35 U.S.C. § 112.

What is claimed is:

1. An electrochemical cell comprising:
a cathode with an active cathode surface;
an anode with an active anode surface opposite the active cathode surface, the anode including:
a frame defining an opening in a plane parallel to the active cathode surface; and
active anode material confined within the opening.

2. The electrochemical cell of claim 1, further comprising a casing encapsulating the cathode and the anode.

3. The electrochemical cell of claim 1, wherein the opening extends over an opening area in the plane, the electrochemical cell further comprising a separator between the active cathode surface and the active anode surface, the separator extending over a separator area greater than the opening area.

4. The electrochemical cell of claim 3, further comprising a liquid electrolyte permeating the separator, wherein the frame is impermeable to the liquid electrolyte.

5. The electrochemical cell of claim 1, wherein the frame adheres to the active anode material.

6. The electrochemical cell of claim 1, wherein the frame is electrically non-conductive.

7. The electrochemical cell of claim 6, wherein the frame is of a polymer.

8. The electrochemical cell of claim 1, wherein the active anode material is of an alkali metal.

9. The electrochemical cell of claim 8, wherein the alkali metal is a metallic lithium.

10. The electrochemical cell of claim 1, wherein the active anode material is a carpet of carbon nanotubes.

11. The electrochemical cell of claim 10, wherein the carbon nanotubes are coated with an alkali metal.

12. The electrochemical cell of claim 11, wherein the alkali metal is metallic lithium.

13. The electrochemical cell of claim 11, further comprising a separator between the cathode and the anode.

14. The electrochemical cell of claim 13, wherein the separator includes an adhesive opposite the anode active material.

15. The electrochemical cell of claim 14, wherein the adhesive includes an aperture opposite the opening.

16. A method for assembling an electrochemical cell, the method comprising:
forming anode active material of an anode area;
forming cathode active material of a cathode area;
electrochemically attaching the anode active material to the cathode active material via a separator of a separator area greater than the anode area; and
framing the anode active material within the anode area.

17. The method of claim 16, wherein the framing comprises encompassing the anode active material within a frame.

18. The method of claim 17, further comprising attaching the frame to the separator.

19. The method of claim 18, wherein attaching the frame to the electrolyte layer comprises attaching the frame to the separator.

20. The method of claim 17, wherein the separator comprises the frame.
